(19) United States
(12) Patent Application Publication
(10) Pub. No.: US 2014/0126877 A1
(43) Pub. Date: May 8, 2014

(54) Controlling Audio Visual Content Based on Biofeedback

(71) Applicants: Richard P. Crawford, Davis, CA (US); Philip J. Corriveau, Forest Grove, OR (US)

(72) Inventors: Richard P. Crawford, Davis, CA (US); Philip J. Corriveau, Forest Grove, OR (US)

(21) Appl. No.: 13/668,499

(22) Filed: Nov. 5, 2012

(51) Int. Cl. H04N 5/765

(52) U.S. Cl. 386/200; 386/E05.002

(57) ABSTRACT

Biofeedback, including cognitive feedback, may be used to provide real time information about a viewer's reaction to an ongoing playback of audio visual content. Cognitive feedback provides electronic feedback related to brain activity. Biofeedback involves using sensed human characteristics to judge a user's reaction to audio visual content.

### BACKGROUND

This relates generally to systems for controlling the playback of audio visual content.

Audio visual content includes audio content such as music, audio books, talk, and podcasts. Visual content can include pictures, images, moving pictures, streaming content, television and movies.

A variety of techniques have been developed for obtaining feedback from users who are viewing or listening to audio visual content. For example various rating services, such as the Nielsen service, ask viewers to provide feedback about what they like and do not like. This feedback can be provided on a real time basis in some cases. For example, using Nielsen boxes, viewers can indicate what they like and do not like in the course of an ongoing television program.

Then given that the broadcast head end knows what was broadcast at a given time in a given location, it can correlate the viewer feedback to a particular portion of the content being broadcast.

In this way, the content providers can get feedback about viewer reaction to television shows and in some cases even sub portions of those shows. Then the content can be modified for future presentations or the feedback can be used to determine what programs to provide to particular users in the future.

### BRIEF DESCRIPTION OF THE DRAWINGS

Some embodiments are described with respect to the following figures:

FIG. 1 is a perspective view of one embodiment of the present invention in use;

FIG. 2 is a flow chart for one embodiment of the present invention;

FIG. 3 is a flow chart for training phase for use in accordance with an embodiment of the type shown in FIG. 2;

FIG. 4 is a schematic depiction for one embodiment;

FIG. 5 is a front elevational view of one embodiment; and

FIG. 6 is a schematic depiction for another embodiment.

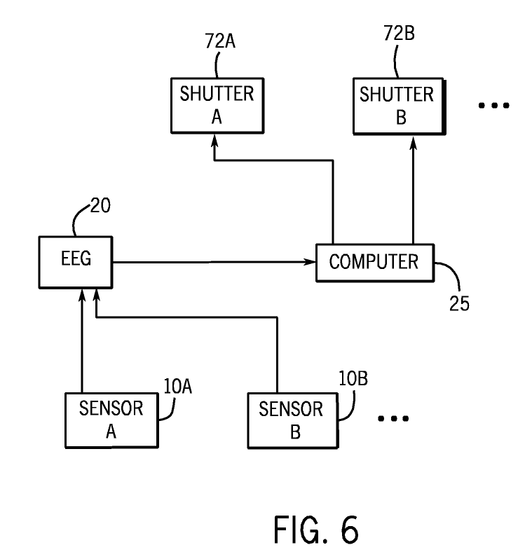

### DETAILED DESCRIPTION

Biofeedback, including cognitive feedback, may be used to provide real time information about a viewer's reaction to an ongoing playback of audio visual content. Cognitive feedback provides electronic feedback related to spatial and temporal aspects of brain activity. Biofeedback involves using sensed human characteristics to judge a user's reaction to audio visual content.

This biofeedback may be used to modify continuing play of the audio visual content, for example by increasing or decreasing certain monitored characteristics. In addition, the biofeedback may be used for other purposes including judging reaction to different advertising, compiling information about viewers for purposes of targeting particular content such as advertising, movies, or other items of interest to particular viewers.

In some embodiments, biofeedback is used non-real time or in an off-line mode to tune future audio visual presentations based on biofeedback, gathered from one or more prior presentations. For example, once a viewer is identified, the audio visual presentation may be varied based on stored biofeedback.

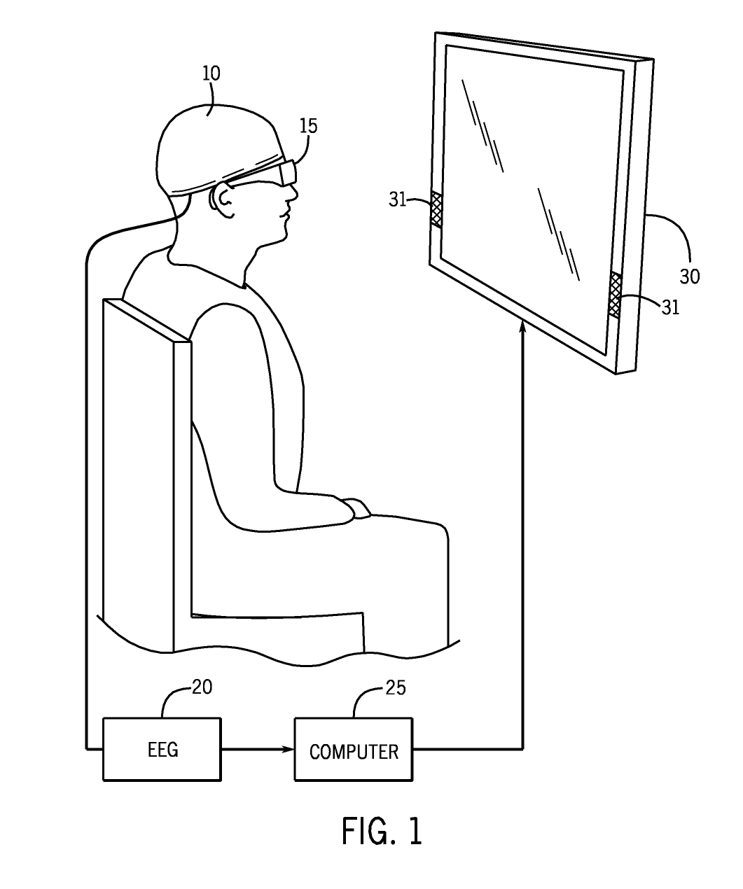

Referring to FIG. 1, a viewer, shown in the seated position, is wearing a cap 10 including an electrode or optode array. The electrodes or optodes may be positioned to provide cognitive feedback. The desired cognitive feedback may be different and therefore, different sensor locations may be used in different circumstances. In some cases, the cap may contain a large number of electrodes or optodes positioned in different locations and data may be received from all of those sensors that are located in positions to obtain cognitive information related to particular types of brain functions.

The user may be positioned to watch an ongoing video display on a display screen 30. The content that is displayed on the display screen may be controlled by a computer 25 coupled to a biofeedback sensor such as an electroencephalograph 20. That is, the content may be modified during the course of the ongoing presentation based on feedback received from the cap 10. In other words, the system may analyze the viewer's reaction, in terms of brain activity, to the content and may tone the content down in various ways or make the content more intense based on the user's desires and the system detected levels of brain activity.

As one example, the user may be wearing stereoscopic glasses 15. The user may react to different levels of stereoscopic effect. If the user brain activity suggests the effect is too intense for that user, the ongoing content may be scaled back to reduce the amount of the stereoscopic effect, producing a flatter picture.

Thus in some embodiments, a decision point in the ongoing audio video playback may enable the substitution of different pre-stored audio visual versions based on cognitive feedback. In some other cases, a single version of the content may be modified on the fly in certain respects. Based on the cognitive feedback, the user can be exposed, after judging the user's reaction, to a more pleasing, ongoing presentation.

However the cognitive feedback may be used for judging many other things including the user's reaction to particular displayed content. For example, the user may have different reactions to the degree of violence, sexual content, emotional content or the amount of activity or action. In response to the user's cognitive feedback, the content (after judging the reaction) may be modified to either increase or decrease the user's reaction. Other audio visual characteristics that may be judged and modified may be frame rate, brightness, contrast, audio level, camera movement and other visual effects.

Cognitive feedback may be obtained by any suitable monitoring device including a electroencephalograph (EEG) or a functional near-infrared spectroscopy (fNIRS) device. Any device that allows assessment of cognitive workload on a real time basis may be used in some cases. The device may be trained by showing the user different audio visual content and determining levels that the user finds desirable. These levels may then be programmed and when certain cognitive feedback is detected, the ongoing audio visual presentation may be modified accordingly.

Thus in the example of stereoscopic viewing, the effect of stereoscopic viewing on brain activity may be monitored to identify signatures of regions of binocular disparity in the brain. A processed signal and indicator may then be used to modulate the three-dimensional depth effect created by independently projected two-dimensional images.

In the example of stereo listening, the effect of stereo on brain activity may be monitored to identify signatures of regions of enhanced activity in the brain. A processed signal and indicator may then be used to modulate the amount of stereo or multichannel audio based on biofeedback.

In group viewing situations, collective feedback from the viewers may be used to tune the ongoing audio visual presentation to a more optimal setting. For example in one embodiment, the content may be tuned to a more optimal setting for a higher percentage of the existing viewers.

In some cases, it is possible to change the frame rate on the fly. In other cases, it may be possible to electronically modify shutters in glasses used to view the stereoscopic effect. In such cases, it may be possible to tune the shutters of individuals users to most appropriate stereoscopic level. Similarly, headphones may include circuits to modulate stereoscopic sound based or biofeedback.

Thus in some cases, based on the cognitive feedback, the ongoing audio visual presentation may be modified. It may be modified, for example, by selecting from among pre-provisioned, alternative, ensuing audio visual content to better meet the user's preferences as recognized from the cognitive feedback. In other cases, a single audio visual presentation may be electronically modified on the fly, for example by electronically changing frame rate or changing the level of the stereoscopic effect.

There are certain fast moving scenes where higher frame rates are more desirable to make things appear smoother. You could have modulation of frame rate based on the amount of motion and blurring and how well someone was handling it (based on biofeedback). The disparity of the images that you are trying to create depth with may be increased or decreased. Also people can view entirely different scenes/audio by using shutters and frame rate synchronization to give certain people one set of frames (e.g. adults or less sensitive viewers) and other people a different set of frames (e.g. children or other more sensitive viewers).

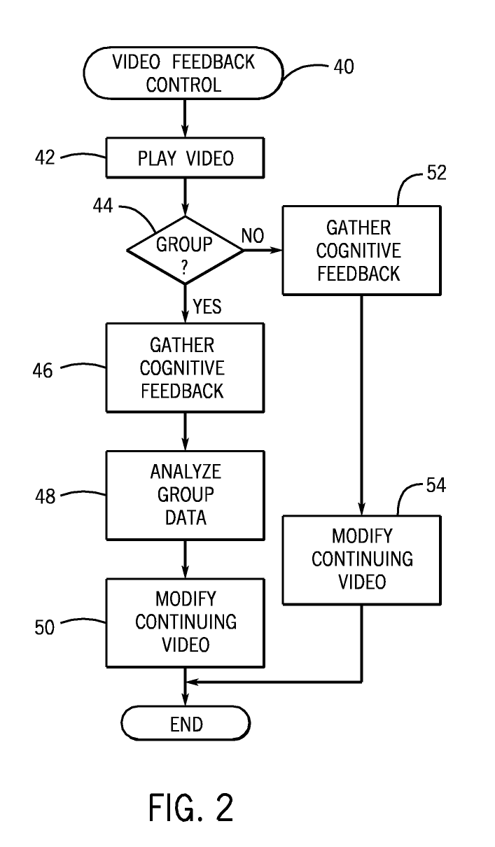

Thus referring to FIG. 2, in accordance with one embodiment, a video feedback control sequence 40 may be implemented in software, firmware and/or hardware. In software and firmware embodiments it may be implemented by computer executed instructions stored in one or more non-transitory computer readable media such as a magnetic, optical or semiconductor storage.

Referring to block 42, initially, a video presentation may be played. A check at diamond 44 determines whether or not one or a group of viewers is watching the video. Data about the number of viewers may be entered in response to prompts provided onscreen or on remote control devices. The user may respond whether two or more people are watching or whether only a single person is watching.

In other embodiments, a video camera associated with the display may automatically determine the number of viewers that are present using video analytics. In some cases, the identities of the viewers can also be determined using video analytics or individually unique signatures of their brain activity either in a nominal state or in response to standard stimuli.

If a group is watching, the cognitive feedback may be obtained using data mined from brain sensors on each of the viewers as indicated in block 46. In other words cognitive feedback is obtained from each of the viewers and analyzed to develop information about the reaction or satisfaction of the group with the ongoing video presentation as indicated in block 48. For example if the level of stereoscopic effect is too little or too much for the majority of the people, this may be determined. Then the continuing video presentation may be modified as indicated in block 50. This may be done in one embodiment by selecting a video segment from a group of available video segments that best matches the group cognitive feedback.

In accordance with another embodiment, each of a group of users may wear stereoscopic glasses 15 and a cap 10. Cognitive feedback from the caps 10 may then be received by EEG 20, and passed to the computer 25 which then sends different signals to shutters 72a, 72b, etc. in each set of glasses 15. As a result, different users, for example with different sensitivities, may be provided with different presentations. The presentations may be driven by the computer 25 based on the analysis of the sensor data from individual users. Thus, the data from a user A, derived from sensor 10a, may be used to control what the user A sees by sending a control signal to the shutter 72a.

For example, alternate frames may be sequenced with different patterns of shutter openings so that users view different content. For example the content A may be a shutter synchronized to frames 1, 3, 5 while content B may be a shutter synchronized to frames 2, 4, 6. As a result, different users may see different content or they may even see content that has been modified based on their sensitivities. The shutters may be active shutter 3D systems that are commercially available. These devices, also known as liquid crystal shutter glasses or active shutter glasses displace stereoscopic 3D images and work by presenting the image intended for the left eye while blocking the user's right eye, and then presenting the right eye image while blocking the user's left eye. This sequence is repeated so rapidly that the interruptions do not interfere with the perceived fusion of the two images into a single three-dimensional image.

Particularly, the transparency of the glasses is controlled electrically by a signal that allows the glasses to alternately darken a glass over one eye and then the other, in synchronization with the screen's refresh rate in some embodiments. The synchronization may be done by wired signals, wirelessly or even using infrared or other optical transmission media.

Alternatively, if only a single individual is present, the cognitive feedback is obtained from that individual as indicated in block 52 and the continuing video may be modified to suit that particular individual at that particular time as indicated in block 54.

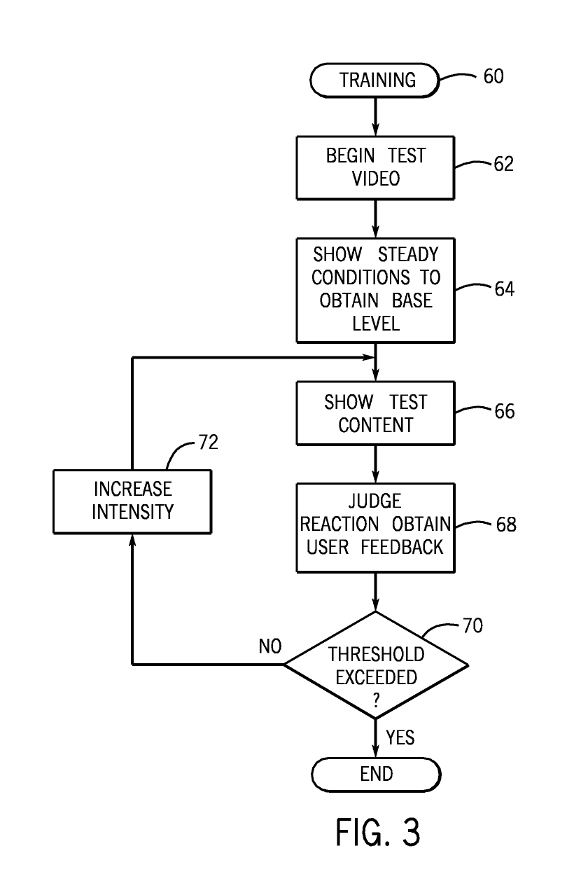

A training sequence 60, shown in FIG. 3 may be implemented in software, firmware and/or hardware. In software and firmware embodiments it may be implemented by computer executed instructions stored in one or more non-transitory computer readable media such as a magnetic, optical or semiconductor storage.

The sequence 60 may begin by showing a test video as indicated in block 62. The test video may have an initial portion that basically shows steady or moderate conditions unlikely to create significant, cognitive feedback for most people. This would provide a baseline set of conditions to determine when the user has a reaction as indicated in block 64.

Then one or more test videos may be played. For example, the level of stereoscopic effect may be increased and then monitoring may judge whether the user reacts as indicated in block 68. In addition, the user may be asked to provide feedback in the form of a graphical user interface about his or her level of satisfaction or dissatisfaction with the ongoing content. Then the cognitive feedback may be matched to the user's personal reaction in order to judge what it is that the user prefers.

At diamond 70, a check determines whether a threshold has been exceeded. That is, if the cognitive feedback indicates that a brain activity threshold has been exceeded, then the flow may be stopped and it may be judged that the user would prefer more or less than that level of cognitive stimulation. If not, the intensity may be increased as indicated in block 72 and the test repeated.

For example, the level of a stereoscopic effect may be increased until feedback from the user indicates an adverse reaction. Once the user indicates an adverse reaction, then it is known that that level of activity is undesirable and it may be advantageous to thereafter modify the ongoing audio visual content in a real (non-training) content viewing situation.

Thus when the user is watching a given audio visual presentation, the levels that were determined in the training phase may be used to determine when the cognitive feedback indicates that modification of the ongoing video presentation may be desirable. A threshold level of brain activity can be stored in the training phase and user to trigger audio visual modification in a real life content playback environment. All of the above embodiments may include audio tuning as well, for example including channel mixing for the different speakers 31 based on cognitive feedback

The information gained from monitoring the user's brain activity and matching it to different levels of audio visual playback characteristics may be used for many other purposes in addition to modification of the ongoing audio visual content playback. For example the user's reaction to particular circumstances, depictions or advertising may be used to judge the user's level of interest or annoyance with different characteristics of the video. This may be used to modify the video in future versions. It may also be used to target different types of content to particular users. For example a user whose brain activity indicates a high degree of affinity for a particular product depicted in an advertisement may then be targeted for future advertisements relating to that product or that type of product. Similarly the user's affinity for a particular type of video or type of music might be used to target the user for future video and music of this type.

Over one or more users, data may be developed which tracks user interest or disinterest in various items. The level of brain activity can be tied to particular items depicted in the video by knowing the time when the brain activity is recorded and the time when the video was displaying a particular object, piece of content, or advertising. Similarly, the actual content itself may be changed. For example if the user's brain activity indicates that the level of violence is too high, an alternative version may be selected for playback which has less violence (either in real-time for the present viewing or identified for use in future selections and playback).

The user's reaction to different elements may be recorded and may be used in the future to automatically adjust playback to the user's sensibilities. Thus, the user's reaction to conventional audio visual playback in terms of violence, sexual content, audio volume, stereoscopic effect, contrast, brightness, etc. may be judged and used to control the way video is played for that particular user in the future. Moreover, this may be fine tuned by monitoring the user's reactions on an ongoing basis. Alternatively, after an initial period when the user watches a number of different videos or audio, all the information that may be needed to control and modulate playback for that particular user may be known. In such case it may no longer be necessary for the user to use the cap but the playback is simply fine-tuned or adjusted for one particular user or one particular crowd.

For example in one system, a television playback system may be associated with a video camera. The video camera may determine which particular users are present. Then the system can look up those characteristics obtained by cognitive feedback in the past for each of those users and may determine an optimal level of different audio visual playback characteristics for the audience that is currently viewing. In this way, the audio playback characteristics may be adjusted on a case by case basis depending who the viewers are at a particular time. It may or may not be necessary for each and everyone of those viewers to wear the cap in order to obtain the necessary feedback because in many cases sufficient feedback may have been developed in the past to know what are the users' sensibilities.

In addition in some systems, brain activity information may be supplemented by other biofeedback information. For example, recordings may be made on ongoing basis of the user's pulse, skin moisture, and eye movements using conventional technologies, such as heart rate meters, eye movement detection systems, and lie detector systems, in order to judge additional information about the user's reaction to particular content. All this information may be used to further refine the brain activity information.

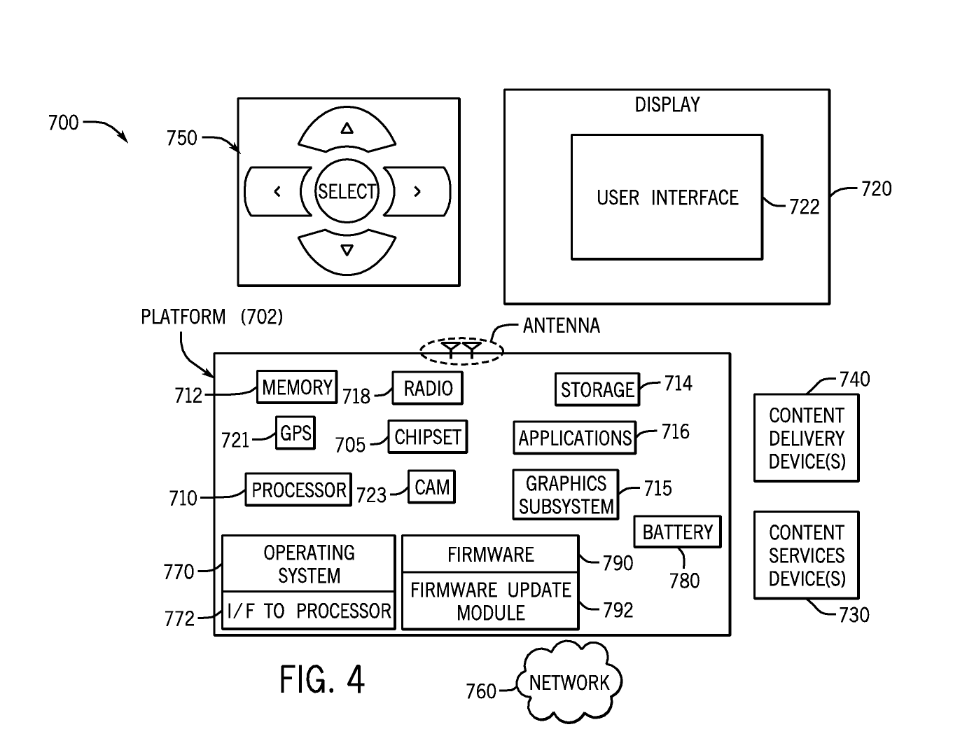

FIG. 4 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

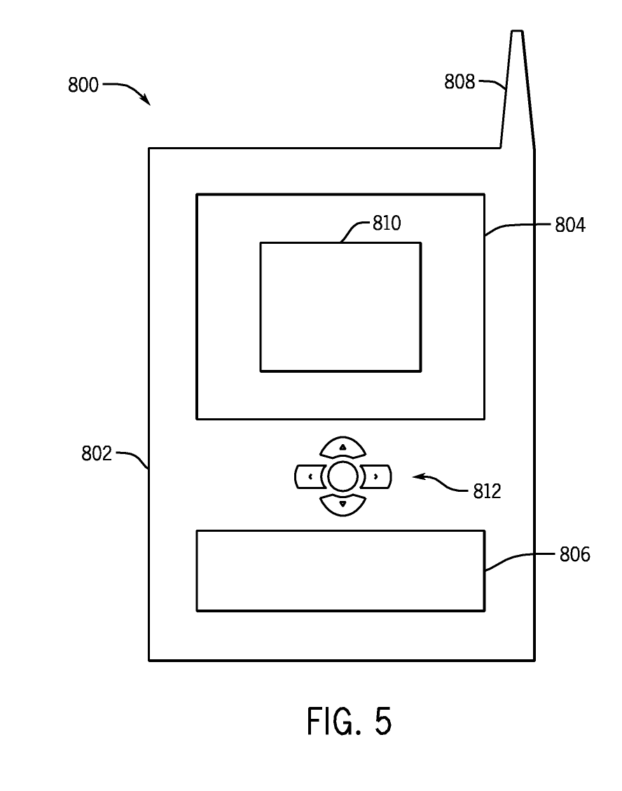

As described above, system 700 may be embodied in varying physical styles or form factors. FIG. 5 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processor 710 may communicate with a camera 722 and a global positioning system sensor 720, in some embodiments. A memory 712, coupled to the processor 710, may store computer readable instructions for implementing the sequences shown in FIG. 2 in software and/or firmware embodiments.

As shown in FIG. 5, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
using biofeedback to electronically modify a computer generated audio or visual presentation.

2. The method of claim 1 wherein using biofeedback includes using a cognitive feedback sensor.

3. The method of claim 1 including selecting between at least two alternative versions of audio visual presentation based on said biofeedback.

4. The method of claim 1 including electronically modifying an ongoing presentation based on said feedback.

5. The method of claim 1 including using biofeedback as an indication of a user's reaction to a level of stereoscopic effect.

6. The method of claim 5 including changing the level of stereoscopic effect in response to biofeedback.

7. The method of claim 1 including using biofeedback as an indicator of a user's reaction to a level of stereo effect.

8. The method of claim 1 including changing the channel mixing for different speakers based on biofeedback.

9. The method of claim 1 including based on biofeedback from two different viewers, providing different audio visual presentations to each of said viewers.

10. The method of claim 1 including changing frame rate in response to biofeedback.

11. One or more non-transitory computer readable media storing instructions executed by a processor to store a sequence comprising:
using biofeedback to modify an audio or visual presentation.

12. The media of claim 11 further storing instructions to perform a sequence wherein using biofeedback includes using a cognitive feedback sensor.

13. The media of claim 11 further storing instructions to perform a sequence including selecting between at least two alternative versions of audio video presentation based on said biofeedback.

14. The media of claim 11 further storing instructions to perform a sequence including electronically modifying an ongoing presentation based on said feedback.

15. The media of claim 11 further storing instructions to perform a sequence including using biofeedback as an indication of a user's reaction to a level of stereoscopic effect.

16. The media of claim 15 further storing instructions to perform a sequence including changing the level of stereoscopic effect in response to biofeedback.

17. The media of claim 11 further storing instructions to perform a sequence including using biofeedback as an indicator of a user's reaction to a level of stereo effect.

18. The media of claim 11 further storing instructions to perform a sequence including changing the channel mixing for different speakers based on biofeedback.

19. The media of claim 11 further storing instructions to perform a sequence including based on biofeedback from two different viewers, providing different audio visual presentations to each of said viewers.

20. The media of claim 11 further storing instructions to perform a sequence including changing frame rate in response to biofeedback.

21. The media of claim 11 further storing instructions to drive two user worn shutters differently based on biofeedback from different users.

22. An apparatus comprising:
a cognitive feedback device; and
a computer coupled to said device to modify an ongoing audio or visual presentation based on cognitive feedback.

23. The apparatus of claim 22 wherein said device is a functional near-infrared spectroscopy device.

24. The apparatus of claim 22 wherein said computer to modify a stereo effect.

25. The apparatus of claim 22, said computer to select between two presentations based on said cognitive feedback.

26. The apparatus of claim 22, said computer to elect to manually modify the presentation based on said feedback.

27. The apparatus of claim 26 said computer to modify the frame rate of the presentation.

28. The apparatus of claim 22 including an operating system.

29. The apparatus of claim 22 including a battery.

30. The apparatus of claim 22 including firmware and a module to update said firmware.
